(19) United States
(12) Patent Application Publication
(10) Pub. No.: US 2026/0148679 A1
(43) Pub. Date: May 28, 2026

(54) SOURCE DRIVER AND DISPLAY DEVICE HAVING THE SAME

(71) Applicant: MAGNACHIP SEMICONDUCTOR, LTD., Cheongju-si (KR)

(72) Inventor: Gil Sung ROH, Cheongju-si (KR)

(73) Assignee: MAGNACHIP SEMICONDUCTOR, LTD., Cheongju-si (KR)

(21) Appl. No.: 19/237,937

(22) Filed: Jun. 13, 2025

(30) Foreign Application Priority Data
Nov. 26, 2024 (KR) 10-2024-0171505

(51) Int. Cl. G09G 3/20

(52) U.S. Cl. CPC G09G 3/2096; G09G 2310/0286; G09G 2310/0289; G09G 2310/0291; G09G 2310/06; G09G 2320/0233; G09G 2320/0242; G09G 2320/0252; G09G 2320/0626; G09G 2320/0673; G09G 2330/06

(57) ABSTRACT

A display device includes a timing controller configured to generate first option data, second option data, a first option enable signal, and a second option enable signal based on image data; a gamma voltage generator configured to output a plurality of gamma voltages; and a source driver including a plurality of switches and configured to receive the plurality of gamma voltages through a plurality of gamma lines. The source driver is configured to adjust turn-on timing of the plurality of switches based on the first and second option data and the first and second option enable signals to reduce a recovery time of the gamma lines.

### CROSS-REFERENCE TO RELATED APPLICATION

This application claims the benefit under 35 U.S.C. § 119(a) of Korean Patent Application No. 10-2024-0171505, filed on Nov. 26, 2024, the entire disclosure of which is incorporated herein by reference in its entirety.

### BACKGROUND

### 1. Field

The present disclosure relates generally to a source driver for a display device, and more particularly to a source driver configured to improve the slew rate by reducing the recovery time of a gamma line, and to a display device including the same.

### 2. Description of the Related Art

The statements in this section merely provide background information related to the present disclosure and do not necessarily constitute prior art.

A source driver converts digital signals corresponding to image data into analog voltages and supplies the analog voltages to respective pixels of a display panel to display images.

As the display market continues to demand higher resolution and improved performance, faster operation of the source driver has become increasingly important.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a display device includes: a timing controller configured to generate first option data, second option data, a first option enable signal, and a second option enable signal based on image data; a gamma voltage generator configured to output a plurality of gamma voltages; and a source driver including a plurality of switches and configured to receive the plurality of gamma voltages through a plurality of gamma lines, wherein the source driver is configured to adjust turn-on timing of the plurality of switches based on the first and second option data and the first and second option enable signals to reduce a recovery time of the gamma lines.

The source driver may include a decoder configured to perform a logical AND operation on the first option data and the first option enable signal to generate a first option execution signal, and to perform a logical AND operation on the second option data and the second option enable signal to generate a second option execution signal.

The plurality of gamma lines may include: a first gamma line including a first switch; a target gamma line including a target switch; a second gamma line including a second switch located between the first switch and the target switch; and a third gamma line including a third switch located between the second switch and the target switch.

The decoder may be configured to receive first to third gamma voltages through the first to third switches, respectively, and to receive a target gamma voltage through the target switch.

The decoder may be configured, in response to the first option execution signal, to sequentially turn on the first switch, the second switch, and the target switch.

The decoder may be configured, in response to the second option execution signal, to turn on the first switch, and thereafter to simultaneously turn on the third switch and the target switch.

The decoder may be configured, in response to the first and second option execution signals, to sequentially turn on the first switch and the second switch, and thereafter to simultaneously turn on the third switch and the target switch.

The source driver may include: a shifter register configured to receive the image data, the first option data, and the second option data; a latch configured to latch the received first and second option data; and a level shifter configured to receive the latched first and second option data.

In another general aspect, a display device includes: a gamma voltage generator; a timing controller; and a source driver. The source driver includes first, second, and third regions, the first region is closest to the gamma voltage generator, the third region is farthest from the gamma voltage generator, the second region is disposed between the first and third regions, and based on a location of a pixel, a determination is made whether to apply a first option, configured to perform voltage charge balancing using a target gamma line and another gamma line, or a second option, configured to short the target gamma line and an adjacent gamma line, to reduce a recovery time of the gamma line.

The source driver may include: a shifter register configured to receive channel-specific image data and first and second option data based on the image data; a latch configured to latch the received first and second option data; a level shifter configured to receive the latched first and second option data; and a decoder configured to receive the first and second option data from the level shifter.

The decoder may be further configured to receive a first option enable signal and a second option enable signal from the timing controller.

The decoder may be configured to perform a logical AND operation on the first option data and the first option enable signal to generate a first option execution signal, and to perform a logical AND operation on the second option data and the second option enable signal to generate a second option execution signal.

The first region may be a region in which neither the first option nor the second option is applied, the second region may be a region in which only one of the first option and the second option is applied, and the third region may be a region in which both the first and second options are simultaneously applied.

The timing controller may be configured to selectively adjust boundaries between the first, second, and third regions.

In another general aspect, a method of operating a source driver for driving a display panel includes: generating an option execution signal based on image data; generating a plurality of gamma voltages using a plurality of resistors connected in series; transmitting the plurality of gamma voltages to a decoder included in the source driver through a plurality of gamma lines; and reducing a recovery time of the plurality of gamma lines by controlling turn-on operations of a plurality of switches included in the decoder based on the option execution signal.

The transmitting of the generated plurality of gamma voltages to the decoder may include: transmitting a first gamma voltage through a first switch; transmitting a target gamma voltage through a target switch; transmitting a second gamma voltage through a second switch disposed between the first switch and the target switch; and transmitting a third gamma voltage through a third switch disposed between the second switch and the target switch.

The generating of the option execution signal based on the image data may includes: performing a logical AND operation on first option data and a first option enable signal to generate a first option execution signal; and performing a logical AND operation on second option data and a second option enable signal to generate a second option execution signal.

The reducing of the recovery time of the gamma lines may include: in response to the first option execution signal, sequentially turning on the first switch, the second switch, and the target switch.

The reducing of the recovery time of the gamma lines may include: in response to the second option execution signal, turning on the first switch and, thereafter, simultaneously turning on the third switch and the target switch.

The reducing of the recovery time of the gamma lines may include: in response to both the first and second option execution signals, sequentially turning on the first switch and the second switch, and thereafter simultaneously turning on the third switch and the target switch.

Other features and aspects will be apparent from the following detailed description, the drawings, and the claims.

### BRIEF DESCRIPTION OF THE DRAWINGS

FIG. 1 is a set of graphs illustrating a relationship between a gamma voltage and a target voltage of a source driver when an output terminal of the source driver is boosted.

FIG. 2 is a set of graphs illustrating a process in which a driving voltage of a source driver follows a gamma voltage and reaches a target voltage.

FIG. 3 is a block diagram illustrating a configuration of a source driver including a general decoder and a general source amplifier.

FIG. 4 is a block diagram illustrating a gamma line that supplies a gamma voltage to a source driver.

FIG. 5 is a block diagram illustrating an overall configuration of a display device configured to reduce the recovery time of a gamma line, according to an example of the present disclosure.

FIG. 6 is a block diagram illustrating a source driver including a gamma voltage generator, a decoder, and an output amplifier, according to an example of the present disclosure.

FIG. 7 is a timing diagram illustrating a process for reducing noise applied to a target line in order to decrease the recovery time of a gamma line, according to a first option example of the present disclosure.

FIG. 8 is a timing diagram illustrating a process for reducing noise applied to a target line in order to decrease the recovery time of a gamma line, according to a second option example of the present disclosure.

FIG. 9 is a timing diagram illustrating a process for reducing noise applied to a target line in order to decrease the recovery time of a gamma line, according to a third option example of the present disclosure.

FIG. 10 is a block diagram illustrating a configuration for reducing the recovery time of a gamma line, according to a fourth option example of the present disclosure.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The use of the term “may” herein with respect to an example or embodiment, e.g., as to what an example or embodiment may include or implement, means that at least one example or embodiment exists where such a feature is included or implemented, while all examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

The present disclosure provides a solution for improving the slew rate of a source driver by reducing the recovery time of a gamma line.

The present disclosure provides a solution for reducing the recovery time of a gamma line, thereby improving the slew rate of a source driver.

The present disclosure also provides a solution for suppressing voltage peaks in the source driver by removing noise from the gamma line.

The present disclosure provides a source driver and a display device having improved operational characteristics.

The technical problems addressed by the present disclosure are not limited to those described above, and additional technical challenges will be readily apparent to those skilled in the art from the following description.

A detailed description is given below, with reference to attached drawings.

As is well known, various methods have been proposed to enable faster operation of source drivers; however, many limitations still remain. In response to such demands, efforts have been made to improve the slew rate of the source driver by applying conventional techniques, such as boosting the output stage of the source driver—for example, by employing a source slew rate boosting method.

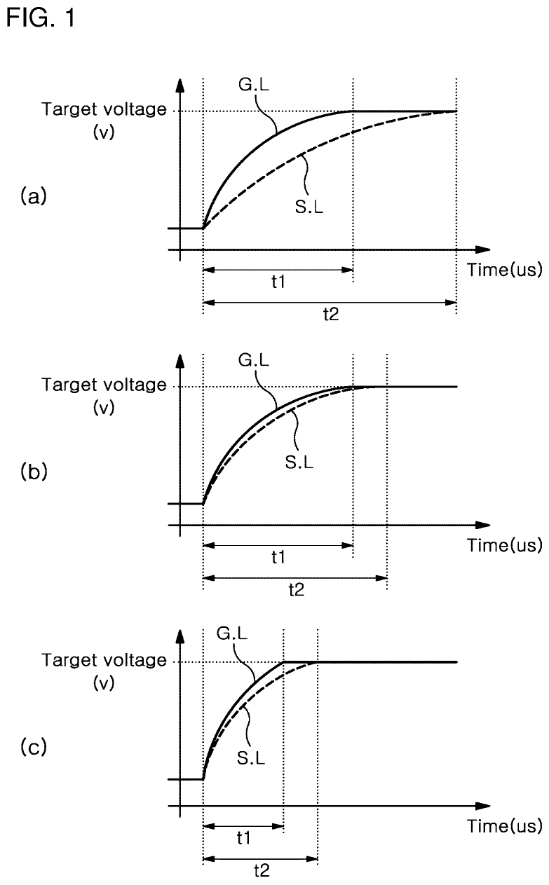

For example, (a), (b), and (c) of FIG. 1 is a set of graphs illustrating the relationship between a gamma voltage and a target voltage of the source driver.

Referring to the graphs of FIG. 1, in a display device, as shown in part (a) of FIG. 1, the gamma voltage (G.L) has a certain slew rate, whereas the driving voltage (S.L) of the source driver exhibits a relatively slower slew rate. Accordingly, the output stage of the source driver was boosted so that the driving voltage (S.L) of the source driver follows the gamma voltage (G.L), as shown in part (b) of FIG. 1. As a result, as shown in part (c) of FIG. 1, the time (t1) required for the driving voltage (S.L) to reach the gamma voltage (G.L) was minimized.

Nevertheless, if a problem occurs in the gamma line that supplies gamma voltage to the source driver, the driving performance of the source driver may be degraded. In other words, even if the output stage of the source driver is improved, it is difficult to achieve a transition speed that exceeds the variation speed of the gamma line, which is the input stage of the source driver.

When the slew rate of the source driver is insufficient, an issue may arise in which abnormal color rendering appears in the image displayed on the screen of the display device.

Such a problem can also arise when noise is generated at the input stage of the source driver. In this case, if the recovery time of the gamma line is not sufficiently fast, the time required for the driving voltage of the source driver to reach the predetermined target voltage of the display device may increase.

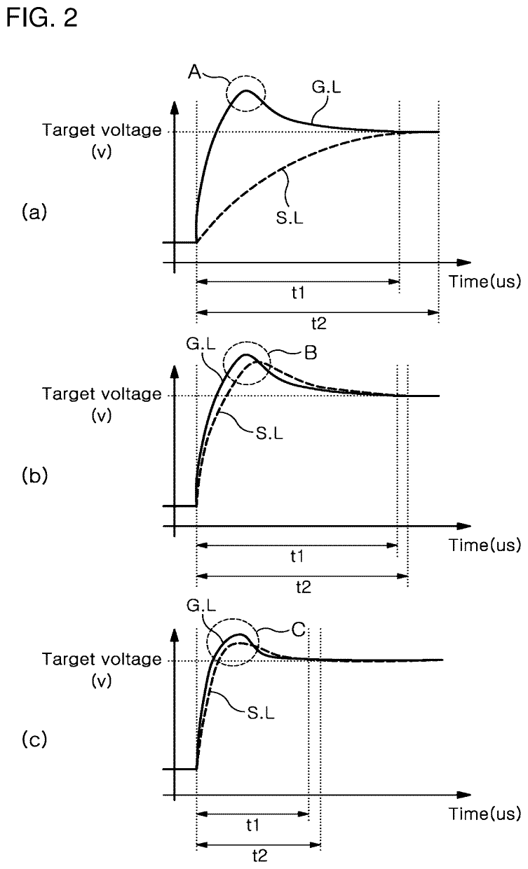

In addition, as shown in part (a) of FIG. 2, the driving voltage (S.L) of the source driver is controlled to follow the gamma voltage (G.L) and reach the target voltage. However, when a change in the gamma voltage level occurs due to the large number of channels required for high resolution, a peak voltage—also referred to as noise—may be generated in the gamma line (G.L) near the target voltage, as indicated in region A. This affects the output of the source driver as well, causing peak voltages to appear in the driving voltage (S.L) output of the source driver, as illustrated in part (b) and part (c) of FIG. 2 (regions B and C).

The causes of peak voltage generation in the gamma line may vary.

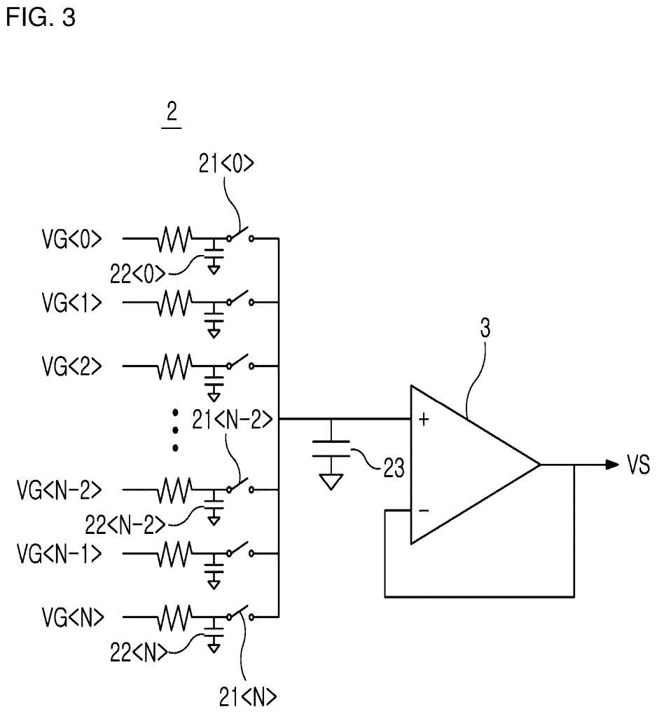

For example, referring to FIG. 3, which is a block diagram illustrating a configuration of a typical source driver including a decoder and a source amplifier, a decoder 2 receives image data and an enable signal, determines a specific gamma voltage (e.g., VG<0>) corresponding to an output voltage (VS) to be output from a source amplifier (Source AMP) 3 based on the image data, and selects a gamma line corresponding to the determined specific gamma voltage (VG<0>). In other words, the specific gamma voltage (VG<0>) applied to the gamma line selected by the decoder 2 may be input as an input voltage to the source amplifier 3. Here, the decoder 2 may further include a plurality of switches 21<0> to 21<N> and a plurality of capacitors 22<0> to 22<N> for determining whether voltages are delivered to each of the gamma lines.

According to the specific gamma voltage (VG<0>) selected by the decoder 2, the specific gamma voltage (VG<0>) is charged into a parasitic metal capacitance 23 located between the capacitor 22<0> of the corresponding gamma line and the switch 21<0> and the source amplifier 3. Subsequently, when the gamma voltage changes from the specific gamma voltage (VG<0>) to a target gamma voltage (e.g., VG<N−2>), a voltage fluctuation occurs in the gamma line corresponding to the new selection, due to the balancing between (i) the voltage charged in the capacitor 22<0> and the parasitic metal capacitance 23 of the previously selected gamma line, and (ii) the voltage charged in the capacitor 22<N−2> of the newly selected gamma line. As a result, a peak voltage (i.e., noise) is generated in the gamma line.

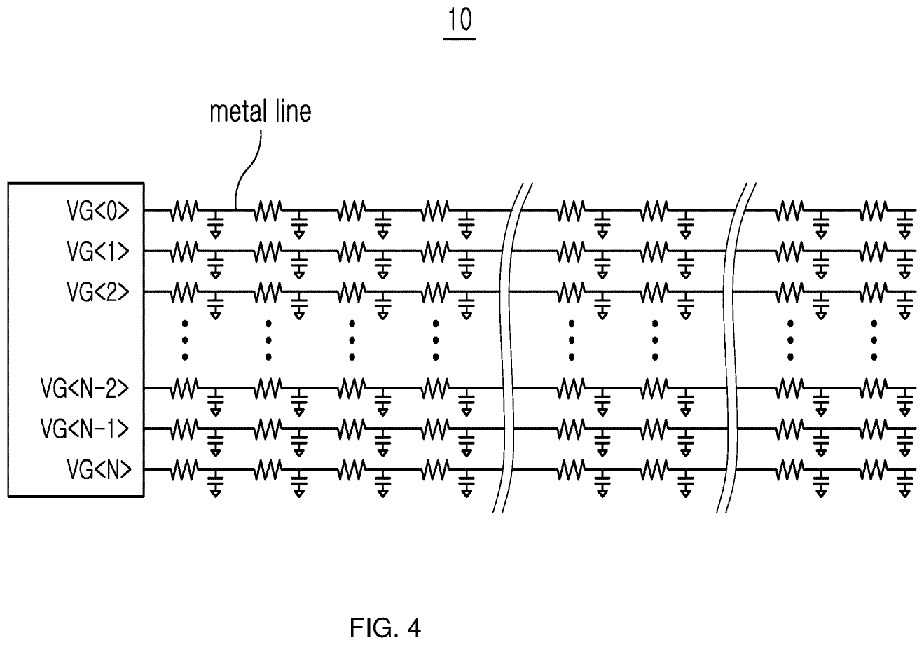

In another example, referring to the structural diagram of the gamma line shown in FIG. 4, the gamma line (10) includes metal lines that are extended laterally and configured to generate gamma voltages (VG<0> to VG<N>) corresponding to display data from a gamma voltage generator, and to supply those voltages to a source driver.

In such a configuration, as a segment of the gamma line becomes farther from the gamma voltage generator, the gamma resistance of that segment increases, thereby degrading the ability of the gamma line to recover from a peak voltage (i.e., noise).

However, the issue of peak voltage can be alleviated by reducing the resistance of the gamma line. In other words, a lower gamma line resistance enables faster voltage recovery, even when a peak voltage occurs. Nevertheless, since the source driver is designed in a laterally elongated form and the width of the metal lines constituting the gamma line is a critical factor in determining the overall chip size, there are physical constraints on increasing the line width to reduce resistance.

Accordingly, the resistance of the gamma line may be reduced by stacking metal layers or increasing the line width, thereby shortening the settle time. As used herein, the term “settle time” refers to the time required for the driving voltage of the source driver to follow or reach the corresponding gamma voltage.

However, such a structure—where metal layers are stacked or the line width is increased—requires additional metal resources, which in turn results in increased process costs as another drawback.

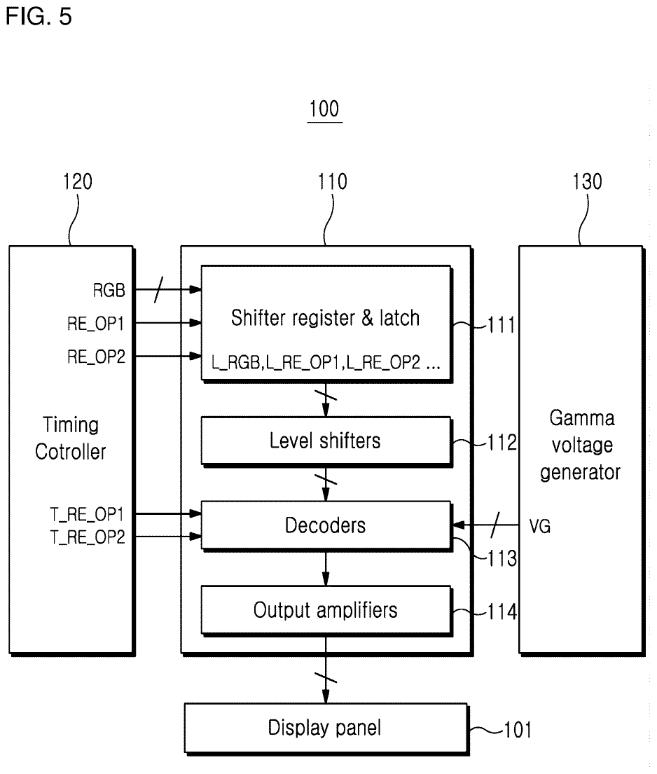

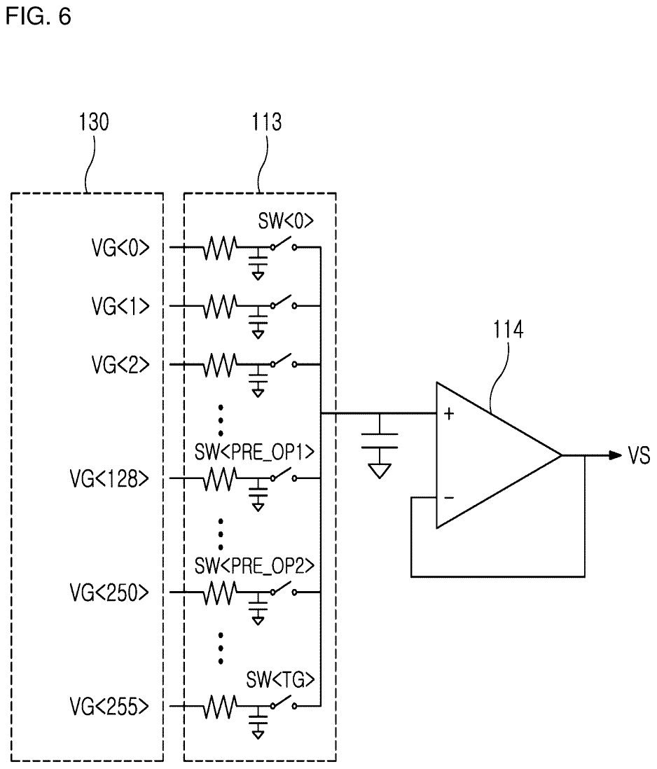

FIG. 5 is a block diagram illustrating the overall structure of a display device for reducing the recovery time of a gamma line according to an example of the present disclosure. FIG. 6 is a block diagram illustrating a source driver including a gamma voltage generator, decoders, and an output amplifier according to an example of the present disclosure.

A display device 100 according to an example of the present disclosure may include a display panel 101, a source driver 110, a timing controller 120, and a gamma voltage generator 130.

A plurality of data lines and a plurality of gate lines intersect in the display panel 101, and pixels are arranged in a matrix form at each intersection. The display panel may be a flat panel display such as a TFT-LCD, PDP, LED display, or OLED, but is not limited thereto.

The source driver 110 converts image data (RGB) into analog pixel signals according to data timing control signals applied from the timing controller 120 during display operation and supplies the analog pixel signals to the data lines. The configuration of the source driver 110 will be described in detail below.

The timing controller 120 supplies a gate control signal (GCS) to a gate driver (not shown) and a data control signal (DCS) to the source driver 110 to control driving timing, supplies image data to the source driver 110, and controls the gate driver by the gate control signal (GCS) such that the gate scan direction is converted on a frame-by-frame basis. According to an example of the present disclosure, the timing controller 120 provides the source driver 110 with the image data, option data determined by the image data, and an option enable signal in data form. In other words, the timing controller 120 determines which option to use for each channel based on information about changes in the image data for that channel.

The option data may include first option data RE_OP1 and second option data RE_OP2, which are delivered to a decoder 113 via a shifter register & latch 111 and a level shifter 112. Options based on the first and second option data may include a first option OP1 and a second option OP2. The first option OP1, based on the first option data RE_OP1, reduces noise applied to a target line by using charge balancing. The second option OP2, based on the second option data RE_OP2, discharges noise applied to the target line by shorting adjacent gamma lines.

The gamma voltage generator 130 generates gamma voltages VG by gray level within a grayscale range and supplies them to the source driver 110. In other words, the display device 100 requires gamma voltages VG having accurate and consistently constant values to maintain stable display quality. The gamma voltage generator 130 generates the gamma voltages VG using a plurality of resistors arranged in series, and the source driver 110 converts pixel data into analog pixel signals using the gamma voltages VG supplied from the gamma voltage generator 130. Here, the pixel data may generally be digital signals having values between 0 and 255.

Referring to FIG. 5, the source driver 110 may include a shifter register & latch 111, level shifters 112, decoders 113, and output amplifiers 114. Each component included in the source driver 110 is not limited to the embodiment illustrated in FIG. 5 and may be implemented in various other forms. Although only one of each component is shown in FIG. 5, they may be provided in proportion to the number of gamma lines.

The shifter register & latch 111 may control the operating timing of each of the plurality of sampling circuits included in the level shifters 112 in response to a horizontal synchronization signal (Hsync). The horizontal synchronization signal Hsync may be a signal having a predetermined period.

The level shifters 112 may sample and store image data in accordance with the shift sequence of the shifter register & latch 111. The level shifters 112 may output the image data to the decoders 113.

The decoders 113 may receive the image data together with a plurality of gamma voltages VG. In one example, the number of gamma voltages VG may be determined based on the bit depth of the image data. For example, when the image data is 8-bit data, the number of gamma voltages VG may be 256 or fewer; and when the image data is 10-bit data, the number of gamma voltages VG may be 1024 or fewer.

The decoders 113 may receive the first and second option data RE_OP1 and RE_OP2 latched in the shifter register & latch 111, and the first and second option enable signals T_RE_OP1 and T_RE_OP2 generated by the timing controller 120. The decoders 113 may receive the first and second option data RE_OP1 and RE_OP2 latched in the shifter register & latch 111, and the first and second option enable signals T_RE_OP1 and T_RE_OP2 generated by the timing controller 120. The decoders 113 may perform the first option OP1 in response to a first option execution signal at a logic high level, the signal being generated by performing a logical AND operation on the first option data RE_OP1 and the first option enable signal T_RE_OP1. The decoders 113 may also perform the second option OP2 in response to a second option execution signal at a logic high level, the signal being generated by performing a logical AND operation on the second option data RE_OP2 and the second option enable signal T_RE_OP2.

The output amplifiers 114 may include a plurality of unit buffers, which may be implemented, for example, using operational amplifiers. The plurality of unit buffers may be connected to a plurality of data lines included in the display panel.

According to an example of the present disclosure, in addition to the first option OP1 and the second option OP2, a third option OP3 and a fourth option OP4 may also be provided as a measure to further improve the recovery time of a gamma line.

The third option OP3 is a control option that enables simultaneous application of both the first option OP1 and the second option OP2.

The fourth option OP4 is a control option that allows selection and control of a region of the source driver elongated in the horizontal direction, taking into account the resistance of the gamma line. The first option data RE_OP1 and the second option data RE_OP2, which are used to apply the first option OP1 and the second option OP2, may be transmitted together with image data through the shifter register & latch 111, and since they are available via the shifter register & latch 111, specific data may be applied to specific regions of the display panel 101. Therefore, the options can be applied differently by region for selective control. For example, since regions farther from the gamma area are more vulnerable in terms of recovery time, both the first option and the second option may be applied simultaneously in those regions. In intermediate regions, either the first option or the second option may be applied, and in closer regions, the options may be disabled. Furthermore, even in cases where the first option or the second option, or both, are applied, the operation of the options may be suppressed by calculating the variation in the image data.

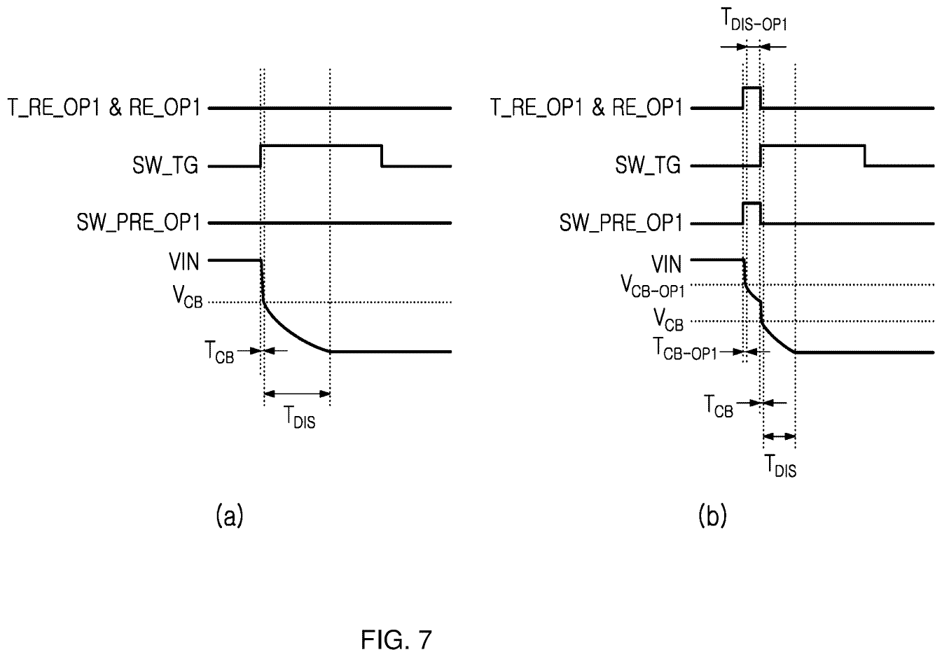

The operation of each of these options will be described with reference to the plurality of switches included in FIG. 6 and the timing diagrams shown in FIGS. 7 to 9.

FIG. 7 is a timing diagram illustrating a process for reducing noise applied to a target line in order to decrease the recovery time of a gamma line, according to a first option example of the present disclosure.

The target voltage described in the example of the present disclosure refers to the final output voltage that the source driver 110 aims to output to a desired level. In other words, the gamma voltage generator 130 generates the lowest and highest voltages, and the target voltage is a voltage that must be driven in a changed level state (from a high level to a low level, or from a low level to a high level) with respect to the gamma line reference.

Referring to part (a) of FIG. 7, after the target switch SW_TG is turned on, the source driver input voltage VIN changes until it reaches the charge balancing voltage VCB during the charge balancing time T_{CB}. Thereafter, the target voltage is provided through the gamma line during the discharge time T_{DIS}. As previously described, charge balancing is a factor that may induce a specific peak voltage, and thus it is necessary to reduce the recovery time by utilizing adjacent gamma lines.

Part (b) of FIG. 7 illustrates a case in which the timing controller 120 determines the first option based on the image data and the first option data RE_OP1. The first option is a method of reducing noise on the target line by performing charge balancing with another gamma line.

Referring to part (b) of FIG. 7, an additional charge balancing operation is performed one more time.

Specifically, charge balancing is performed with reference to the timing at which each switch, SW_PRE_OP1 and SW_TG, is turned on.

In the first charge balancing operation, SW_PRE_OP1 is turned on by a signal obtained through a logical AND operation between the first option enable signal and the first option data T_{CB-OP1}. Thereafter, during the first charge balancing time T_{CB-OP1}, the decoder 113 performs charge balancing using an adjacent gamma line. Accordingly, during the first discharge time T_{DIS-OP1}, the input voltage VIN is discharged to the voltage of the adjacent gamma line. The first discharge time T_{DIS-OP1} is maintained until the target switch SW_TG is turned on.

In the second charge balancing operation, when the target switch SW_TG is turned on, the second charge balancing time T_{CB} begins, and the voltage transitions to a second charge balancing voltage V_{CB}, which is lower than the first charge balancing voltage V_{CB-OP1}. The target voltage is then provided through the second discharge time T_{DIS}.

It can be seen that the total discharge time, which is the sum of the first discharge time T_{DIS-OP1} and the second discharge time T_{DIS} shown in part (b) of FIG. 7, is reduced compared to the discharge time T_{DIS} shown in part (a) of FIG. 7.

In the case where charge balancing is performed twice as illustrated in part (b) of FIG. 7, for example, when the decoder 113 shown in FIG. 6 changes the gamma voltage from VG0 to VG255, noise on the target gamma line may be reduced by using an intermediate gamma voltage, such as VG128.

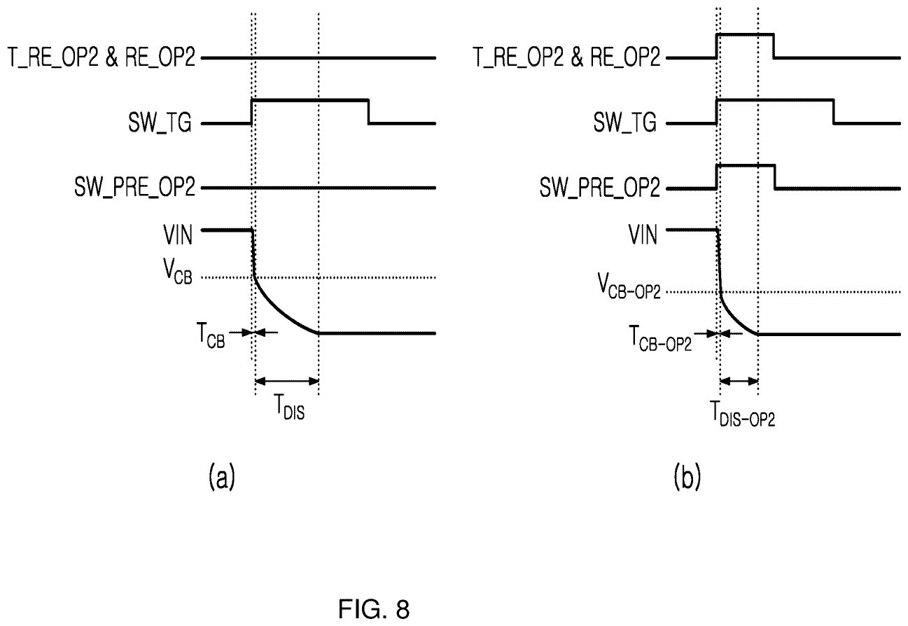

FIG. 8 is a timing diagram illustrating a process for reducing noise applied to a target line in order to decrease the recovery time of a gamma line, according to a second option example of the present disclosure.

Referring to part (a) of FIG. 8, after the target switch SW_TG is turned on, the source driver input voltage VIN changes until it reaches the charge balancing voltage V_{CB} during the charge balancing time T_{CB}. Thereafter, the target voltage is provided through the discharge time T_{DIS} via the gamma line. As previously described, charge balancing is a factor that may induce a specific peak voltage, and therefore, it is necessary to reduce the recovery time by utilizing adjacent gamma lines.

Part (b) of FIG. 8 illustrates a case in which a timing controller 120 selects the second option based on the image data and the second option data RE_OP2. The second option reduces noise on the target line by shorting it to another gamma line.

Referring to part (b) of FIG. 8, a decoder 113 turns on a switch SW_PRE_OP2 by a signal generated through a logical AND operation between a second option enable signal and second option data (T_RE_OP2 & RE_OP2), and simultaneously turns on a target switch SW_TG to short a target line and an adjacent line, thereby forming a parallel path for discharge. As a result, the resistance of the discharge path is reduced, and an input voltage VIN is rapidly changed to a charge balancing voltage V_{CB-OP2} during a charge balancing time T_{CB-OP2}. Thereafter, a voltage shared in a manner similar to a target voltage is provided through a discharge time T_{DIS-OP2} via a gamma line.

It can be seen that a discharge time T_{DIS-OP2} shown in part (b) of FIG. 8 is reduced compared to a discharge time T_{DIS} shown in part (a) of FIG. 8.

In the case where a target line is shorted to an adjacent line as illustrated in part (b) of FIG. 8, for example, when the decoder 113 illustrated in FIG. 6 changes a gamma voltage from VG0 to VG255, noise on the target gamma line may be reduced by using an adjacent gamma voltage such as VG250.

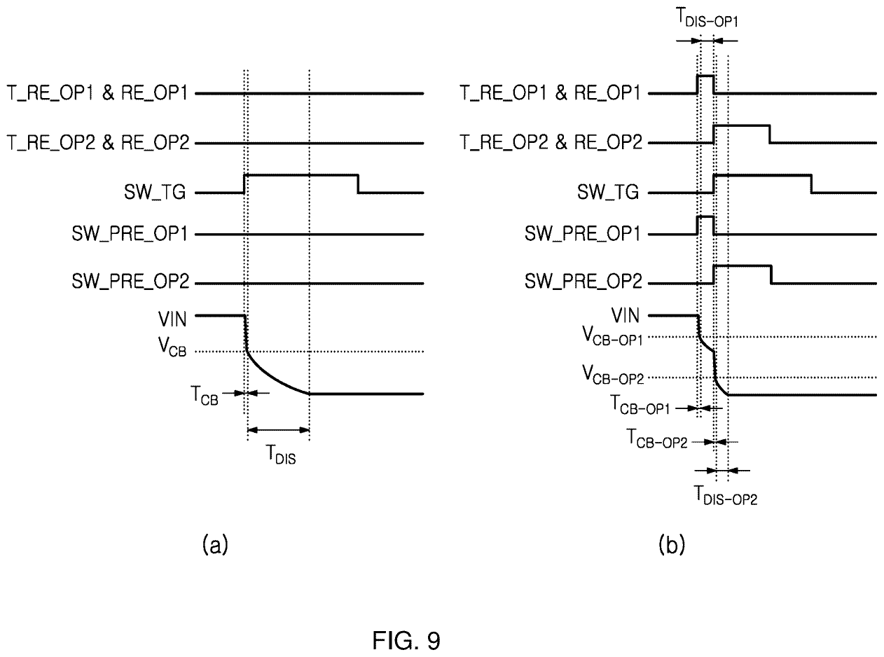

FIG. 9 is a timing diagram illustrating a process for reducing noise applied to a target line in order to decrease the recovery time of a gamma line, according to a third option example of the present disclosure.

Referring to part (a) of FIG. 9, after a target switch SW_TG is turned on, an input voltage VIN of a source driver changes until it reaches a charge balancing voltage V_{CB} during a charge balancing time T_{CB}. Thereafter, a target voltage is provided through a discharge time T_{DIS} via a gamma line. As previously described, charge balancing is a factor that may induce a specific peak voltage, and therefore, it is necessary to reduce the recovery time by utilizing an adjacent gamma line.

Part (b) of FIG. 9 illustrates a case in which the first option and the second option are used sequentially.

Referring to part (b) of FIG. 9, in the charge balancing operation according to the first option, a switch SW_PRE_OP1 is turned on by a signal generated through a logical AND operation between a first option enable signal and first option data (T_RE_OP1 & RE_OP1). Thereafter, during a first charge balancing time T_{CB-OP1}, a decoder 113 performs charge balancing with an adjacent gamma line. Accordingly, during a first discharge time T_{DIS-OP1}, an input voltage VIN is discharged to the voltage of the adjacent gamma line. The first discharge time T_{DIS-OP1} is maintained until a target switch SW_TG is turned on. Subsequently, the second option is activated by a signal generated through a logical AND operation between a second option enable signal and second option data (T_RE_OP2 & RE_OP2), and both the switch SW_PRE_OP2 and the target switch SW_TG are turned on simultaneously. During a second charge balancing time T_{CB-OP2}, the decoder 113 shorts to an adjacent gamma line, causing the voltage to transition to a second charge balancing voltage V_{CB-OP2}, which is lower than the first charge balancing voltage V_{CB-OP1}. Thereafter, a voltage shared in a manner similar to a target voltage is provided through a second discharge time T_{DIS-OP2} via the gamma line.

It can be seen that the total discharge time, which is the sum of the first discharge time T_{DIS-OP1} and the second discharge time T_{DIS-OP2} shown in part (b) of FIG. 9, is reduced compared to the discharge time T_{DIS} shown in part (a) of FIG. 9.

In the case where charge balancing is performed twice and the target line is shorted to an adjacent line as illustrated in part (b) of FIG. 9, for example, when the decoder 113 illustrated in FIG. 6 changes the gamma voltage from VG0 to VG255, the gamma voltage may first be changed using an intermediate gamma voltage such as VG128, and then noise on the target gamma line may be reduced by using an adjacent gamma voltage such as VG250.

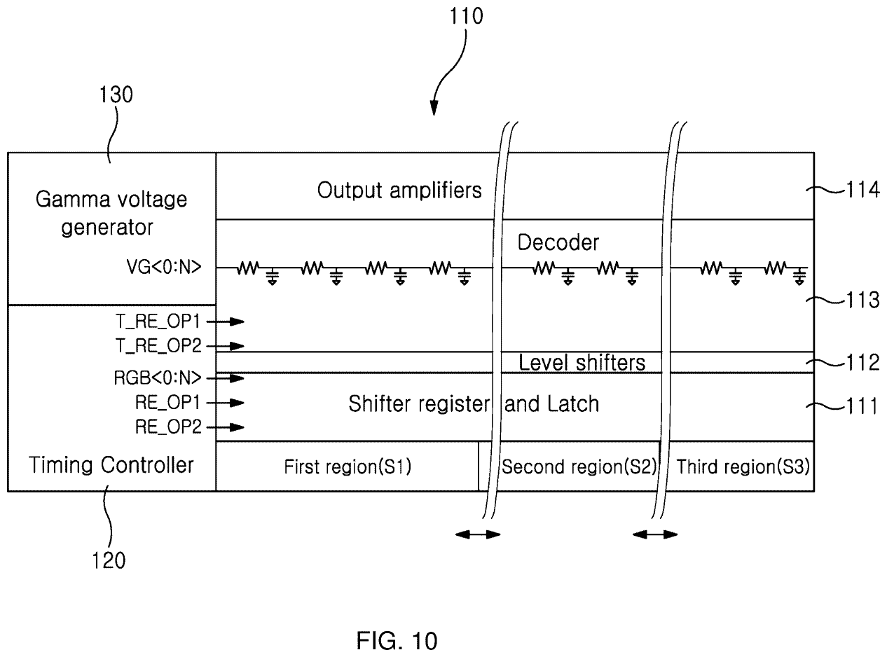

FIG. 10 is a block diagram illustrating a configuration for reducing the recovery time of a gamma line according to a fourth option example of the present disclosure.

FIG. 10 illustrates only the components necessary to describe recovery time improvement in a display device 100, including a gamma voltage generator 130, a timing controller 120, and a source driver 110. This configuration corresponds to the same display device described in FIG. 5, with only a portion illustrated.

Referring to FIG. 10, the gamma voltage generator 130 and the timing controller 120 are arranged vertically, and the source driver 110 is extended in one direction from the gamma voltage generator 130 and the timing controller 120. The source driver 110 includes a shifter register and latch 111, level shifters 112, a decoder 113, and output amplifiers 114. A gamma line for applying gamma voltages is formed to extend along a decoder 113. The decoder 113 receives T_RE_OP1 and T_RE_OP2 signals, and the shifter register and latch 111 receives image data, RE_OP1, and RE_OP2 signals.

The source driver 110 includes a first region S1, a second region S2, and a third region S3. These regions may represent portions of the source driver 110 segmented in a horizontal direction. The regions are arranged sequentially from one end of the gamma voltage generator 130 and the timing controller 120, such that the first region S1 is closest to the gamma voltage generator 130, and the third region S3 is farthest. The boundaries of the regions S1 to S3 may be selectively defined by the timing controller 120, and thus the area of each region may be variable.

Since the gamma line resistance in the first region S1 is relatively small due to its proximity to the gamma voltage generator 130, no recovery enhancement is required. Therefore, the first region S1 serves as a non-application zone for the first option OP1 and the second option OP2. The second region S2 may be a zone where either the first option OP1 or the second option OP2 is applied. Within the second region S2, the first option OP1 may be applied to sub-regions where the resistance of the gamma line is relatively low, and the second option OP2 may be selectively applied to sub-regions where the resistance of the gamma line is relatively high. The third region S3 may be a zone where both the first option OP1 and the second option OP2 are simultaneously applied In other words, the source driver 110 is divided into a plurality of regions such that, in a region close to the gamma area, the options are disabled; in a region farthest from the gamma area, both options are enabled simultaneously; and in an intermediate region, only one of the options is selectively enabled. Furthermore, even when the first option, the second option, or both options are applied to each of the regions S1 to S3, the operation of the options may be controlled so as to be disabled based on the calculated variation in image data.

As such, in regions of the source driver where a sufficient slew rate is ensured and no issue arises, the options may be omitted to optimize power consumption. In other regions, the options may be adaptively applied to suppress noise generation on the gamma line.

According to the present disclosure, the recovery time of the gamma line can be improved, thereby enhancing the operational characteristics of both the source driver and the display device.

According to the present disclosure, noise (e.g., voltage peaks) occurring in the gamma line can be suppressed, and as a result, voltage peak generation in the source driver can also be prevented.

According to the present disclosure, the source driver can be divided into a plurality of regions, and optional functions for improving gamma line recovery can be selectively applied to each region, thereby optimizing the power consumption of both the source driver and the display device.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A display device comprising:
a timing controller configured to generate first option data, second option data, a first option enable signal, and a second option enable signal based on image data;
a gamma voltage generator configured to output a plurality of gamma voltages; and
a source driver comprising a plurality of switches and configured to receive the plurality of gamma voltages through a plurality of gamma lines,
wherein the source driver is configured to adjust turn-on timing of the plurality of switches based on the first and second option data and the first and second option enable signals to reduce a recovery time of the gamma lines.

2. The display device of claim 1,
wherein the source driver further comprises a decoder configured to perform a logical AND operation on the first option data and the first option enable signal to generate a first option execution signal, and to perform a logical AND operation on the second option data and the second option enable signal to generate a second option execution signal.

3. The display device of claim 2, wherein the plurality of gamma lines comprise:
a first gamma line including a first switch;
a target gamma line including a target switch;
a second gamma line including a second switch located between the first switch and the target switch; and
a third gamma line including a third switch located between the second switch and the target switch.

4. The display device of claim 3,
wherein the decoder is configured to receive first to third gamma voltages through the first to third switches, respectively, and to receive a target gamma voltage through the target switch.

5. The display device of claim 3,
wherein, in response to the first option execution signal, the decoder is configured to sequentially turn on the first switch, the second switch, and the target switch.

6. The display device of claim 3,
wherein, in response to the second option execution signal, the decoder is configured to turn on the first switch, and thereafter simultaneously turn on the third switch and the target switch.

7. The display device of claim 3,
wherein, in response to the first and second option execution signals, the decoder is configured to sequentially turn on the first switch and the second switch, and thereafter simultaneously turn on the third switch and the target switch.

8. The display device of claim 1, wherein the source driver comprises:
a shifter register configured to receive the image data, the first option data, and the second option data;
a latch configured to latch the received first and second option data; and
a level shifter configured to receive the latched first and second option data.

9. A display device comprising:
a gamma voltage generator;
a timing controller; and
a source driver,
wherein the source driver comprises first, second, and third regions,
wherein the first region is closest to the gamma voltage generator,
wherein the third region is farthest from the gamma voltage generator,
wherein the second region is disposed between the first and third regions, and
wherein, based on a location of a pixel, a determination is made whether to apply a first option, configured to perform voltage charge balancing using a target gamma line and another gamma line, or a second option, configured to short the target gamma line and an adjacent gamma line, to reduce a recovery time of the gamma line.

10. The display device of claim 9, wherein the source driver comprises:
a shifter register configured to receive channel-specific image data and first and second option data based on the image data;
a latch configured to latch the received first and second option data;
a level shifter configured to receive the latched first and second option data; and
a decoder configured to receive the first and second option data from the level shifter.

11. The display device of claim 10,
wherein the decoder is further configured to receive a first option enable signal and a second option enable signal from the timing controller.

12. The display device of claim 11,
wherein the decoder is configured to perform a logical AND operation on the first option data and the first option enable signal to generate a first option execution signal, and to perform a logical AND operation on the second option data and the second option enable signal to generate a second option execution signal.

13. The display device of claim 9,
wherein the first region is a region in which neither the first option nor the second option is applied,
wherein the second region is a region in which only one of the first option and the second option is applied, and
wherein the third region is a region in which both the first and second options are simultaneously applied.

14. The display device of claim 9,
wherein the timing controller is configured to selectively adjust boundaries between the first, second, and third regions.

15. A method of operating a source driver for driving a display panel, the method comprising:
generating an option execution signal based on image data;
generating a plurality of gamma voltages using a plurality of resistors connected in series;
transmitting the plurality of gamma voltages to a decoder included in the source driver through a plurality of gamma lines; and
reducing a recovery time of the plurality of gamma lines by controlling turn-on operations of a plurality of switches included in the decoder based on the option execution signal.

16. The method of claim 15, wherein the transmitting of the generated plurality of gamma voltages to the decoder comprises:
transmitting a first gamma voltage through a first switch;
transmitting a target gamma voltage through a target switch;
transmitting a second gamma voltage through a second switch disposed between the first switch and the target switch; and
transmitting a third gamma voltage through a third switch disposed between the second switch and the target switch.

17. The method of claim 16, wherein the generating of the option execution signal based on the image data comprises:
performing a logical AND operation on first option data and a first option enable signal to generate a first option execution signal; and
performing a logical AND operation on second option data and a second option enable signal to generate a second option execution signal.

18. The method of claim 17, wherein the reducing of the recovery time of the gamma lines comprises:
in response to the first option execution signal, sequentially turning on the first switch, the second switch, and the target switch.

19. The method of claim 17, wherein the reducing of the recovery time of the gamma lines comprises:
in response to the second option execution signal, turning on the first switch and, thereafter, simultaneously turning on the third switch and the target switch.

20. The method of claim 17, wherein the reducing of the recovery time of the gamma lines comprises:
in response to both the first and second option execution signals, sequentially turning on the first switch and the second switch, and thereafter simultaneously turning on the third switch and the target switch.
